(19) United States
(12) Patent Application Publication
(10) Pub. No.: US 2012/0038448 A1
(43) Pub. Date: Feb. 16, 2012

(54) Transformer and display device using the same

(75) Inventors: Deuk Hoon Kim, Incheon (KR); Geun Young Park, Suwon (KR); Sang Joon Seo, Suwon (KR); Jae Gen Eom, Hwaseong (KR); Myeong Sik Cheon, Suwon (KR)

(73) Assignee: SAMSUNG ELECTRO-MECHANICS CO., LTD., Suwon (KR)

(21) Appl. No.: 13/137,391

(22) Filed: Aug. 10, 2011

(30) Foreign Application Priority Data
Aug. 11, 2010 (KR) 10-2010-0077581
Jun. 21, 2011 (KR) 10-2011-0060137

(51) Int. Cl. H01F 27/29

(52) U.S. Cl. 336/192

(57) ABSTRACT

There is provided a transformer in which lead wires of a coil are disposed to be separated from each other so as to prevent a short-circuit between the lead wires. The transformer includes a winding unit having a plurality of partitions formed on an outer circumferential surface of a tubular body part; a base provided at one end of the winding unit and including at least one external connection terminal protruding outwardly; a coil wound on a bobbin and having a lead wire connected to the external connection terminal; and a core electromagnetically coupled with the coil to thereby form a magnetic path, wherein the bobbin includes at least one lead wire supporting portion protruding outwardly from the partitions, supporting the lead wire and guiding the lead wire to the external connection terminal.

### CROSS-REFERENCE TO RELATED APPLICATIONS

This application claims the priorities of Korean Patent Application Nos. 10-2010-0077581 filed on Aug. 11, 2010 and 10-2011-0060137 filed on Jun. 21, 2011, in the Korean Intellectual Property Office, the disclosures of which are incorporated herein by reference.

### BACKGROUND OF THE INVENTION

1. Field of the Invention

The present invention relates to a transformer, and more particularly, to a transformer in which lead wires of coils can be disposed to be separated from each other so as to prevent the lead wires of coils from being short-circuited.

2. Description of the Related Art

Various electronic apparatuses, such as a television (TV), a monitor, a personal computer (PC), an office automation (OA) apparatus, and the like, require various kinds of power supply. Therefore, a device that converts general AC power supplied from the outside into power required for each electronic appliance is provided in those electronic apparatuses. A switching transformer is primarily used therefor.

In general, the switching transformer converts AC power of 85 to 265V into DC power of 3 to 30V by high-frequency oscillation of 25 to 100 KHz. Therefore, since the switching transformer can stably supply a low-voltage, low-current AC power to the electronic appliance while reducing the sizes of a core and a bobbin, as compared with a general transformer that converts AC power of 85 to 265V into AC power of 3 to 30V by frequency oscillation of 50 to 60 Hz, the switching transformer is widely used for electronic appliances which have undergone a miniaturization trend in recent years.

However, as the switching transformer is miniaturized in this manner, lead wires of coils connected to an external connection terminal of the switching transformer are electrically short-circuited.

In addition, in the case in which a plurality of coils are complexdly wound on a single switching transformer, since a plurality of lead wires are connected with the external connection terminal, such a problem may be more intensified. Therefore, a solution for the problem is required.

### SUMMARY OF THE INVENTION

An aspect of the present invention provides a transformer in which lead wires of coils wound on a small-sized transformer can be easily connected to an external connection terminal without being short-circuited from each other.

According to an aspect of the present invention, there is provided a transformer including: a winding unit having a plurality of partitions formed on an outer circumferential surface of a tubular body part; a base provided at one end of the winding unit and including at least one external connection terminal protruding outwardly; a coil wound on a bobbin and having a lead wire connected to the external connection terminal; and a core electromagnetically coupled with the coil to thereby form a magnetic path, wherein the bobbin includes at least one lead wire supporting portion protruding outwardly from the partitions, supporting the lead wire and guiding the lead wire to the external connection terminal.

The partitions may include a first partition disposed adjacent to the other end of the winding unit; and a second partition spaced apart from the first partition by a predetermined interval and disposed adjacent to the base, and the lead wire supporting portion may be provided on at least one of the first partition and the second partition.

The lead wire supporting portion provided on the first partition may protrude further than the lead wire supporting portion provided on the second partition.

The lead wire supporting portion may protrude in parallel to the external connection terminal.

The coil may include a primary coil wound in a space between the other end of the winding unit and the first partition and in a space between one end of the winding unit and the second partition; and a secondary coil wound in a space between the first partition and the second partition.

Lead wires of the primary coil wound between the other end of the winding unit and the first partition may be connected to the external connection terminal while being supported by the lead wire supporting portion protruding from the first partition.

The base may include a groove-type guide portion guiding the lead wire to the external connection terminal.

The lead wires of the primary coil wound on the space between one end of the winding unit and the second partition may be connected to the external connection terminal while being supported by at least one of the lead wire supporting portion protruding from the second partition and the guide portion of the base.

The primary coil or the secondary coil may include a plurality of coils electrically insulated from each other.

The primary coil or the secondary coil may include at least one general insulated coil and at least one triple insulated coil, and the triple insulated coil may be wound to be disposed at an outermost portion of the winding unit.

The plurality of lead wire supporting portions protruding from the partitions may have different protruding distances.

The lead wire supporting portion may include at least one guide groove into which the lead wire is inserted.

The lead wire supporting portion may have a curved surface in contact with the lead wire.

The external connection terminal may include a rigidity reinforcing groove elongated in a length direction and reinforcing a rigidity of the external connection terminal.

The rigidity reinforcing groove may be formed by a pressing process.

The external connection terminal may have higher density in a portion thereof, in which the rigidity reinforcing groove is formed, as compared with the remaining portion thereof.

The external connection terminal may have at least one coil guiding groove in a side thereof, the at least one coil guiding groove having the lead wire inserted therein when the lead wire of the coil is connected thereto.

The coil guiding groove may be formed in each of both sides of the external connection terminal.

The winding unit may have flange parts protruding outwardly from both ends of the body part, and the base may be provided at an end of at least one flange part.

The transformer may further include a coil skipping unit which is a path for skipping the lead wire to an outer surface of the flange part through an outer periphery of the flange part and connecting the lead wire to the external connection terminal.

The coil skipping unit may include a skipping groove providing a path in which the lead wire moves to a lower surface of the flange part; and a crossing path providing a path in which the lead wire skipped through the skipping groove is disposed to cross the outer surface of the flange part.

The coil skipping unit may be a path formed between the base and a guide block protruding in parallel to the base from the outer surface of the flange part.

The guide block may have an end protruding outwardly from the outer periphery of the flange part, and the skipping groove may be formed by the protruding end of the guide block, the base, and the flange part.

The base may include a groove-shaped guide portion guiding the lead wire to the external connection terminal, and the lead wire may be connected to the external connection terminal via the guide portion or the coil skipping unit.

The coil skipping unit may further include at least one guiding groove formed in a lower surface of the base and switching the lead wire disposed on the crossing path to a direction in which the external connection terminal is disposed.

The guiding groove may have a chamfered part at an edge portion of a side wall contacting the lead wire.

According to another aspect of the present invention, there is provided a transformer including: a winding unit including a tubular body part having a through-hole formed therein and flange parts protruding outwardly from both ends of the body part; a base provided at an end of at least one flange part and having a plurality of external connection terminals disposed thereon; and at least one coil wound on a space formed by an outer circumferential surface of the body part and one surface of the flange part, wherein lead wires of the coil are distributively disposed on one surface and the other surface of the flange part and connected to the external connection terminals so that the lead wires are prevented from intersecting with each other.

According to another aspect of the present invention, there is provided a transformer including: a winding unit on which a coil is wound; and at least one external connection terminal protruding outwardly from an end of the winding unit, wherein the external connection terminal includes a rigidity reinforcing groove elongated in a length direction and reinforcing a rigidity of the external connection terminal.

According to another aspect of the present invention, there is provided a transformer including: a winding unit on which a coil is wound; and at least one external connection terminal protruding outwardly from an end of the winding unit, wherein the external connection terminal includes at least one coil guiding groove in a side thereof, the at least one coil guiding groove having a lead wire of the coil inserted therein when the lead wire of the coil is connected thereto.

According to another aspect of the present invention, there is provided a transformer including: a winding unit having a plurality of partitions formed on an outer circumferential surface of a tubular body part; a base provided at an end of the winding unit and including at least one external connection terminal protruding outwardly; a coil wound on a bobbin and having a lead wire connected to the external connection terminal; and a core electromagnetically coupled with the coil to thereby form a magnetic path, wherein the coil includes at least one general insulated coil and at least one triple insulated coil, and the triple insulated coil is wound to be disposed at an outermost portion of the winding unit.

According to another aspect of the present invention, there is provided a flat panel display device including: a power supply including at least one transformer as described above mounted on a substrate thereof; a display panel receiving power from the power supply; and a cover protecting the display panel and the power supply.

The coil of the transformer may be wound so as to be parallel with the substrate of the power supply.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of a transformer according to an embodiment of the present invention;

FIG. 2 is a schematic perspective view of a bobbin of the transformer shown in FIG. 1;

FIG. 3 is a schematic side view of the bobbin, having a coil wound therearound, of FIG. 2;

FIGS. 4 and 5 are enlarged views of part A of FIG. 1;

FIG. 6 is a perspective view of a transformer according to another embodiment of the present invention;

FIG. 7 is a perspective view showing the bottom of the transformer shown in FIG. 6;

FIG. 8 is a bottom view of the transformer shown in FIG. 6;

FIG. 9 is a cross-sectional view taken along line C-C′ of FIG. 6; and

FIG. 10 is a schematic exploded perspective view of a flat panel display device according to an embodiment of the present invention.

### DETAILED DESCRIPTION OF THE PREFERRED EMBODIMENT

Prior to a detailed description of the present invention, the terms or words, which are used in the specification and claims to be described below, should not be construed as having typical or dictionary meanings. The terms or words should be construed in conformity with the technical idea of the present invention on the basis of the principle that the inventor(s) can appropriately define terms in order to describe his or her invention in the best way. Embodiments described in the specification and structures illustrated in drawings are merely exemplary embodiments of the present invention. Thus, it is intended that the present invention covers the modifications and variations of this invention, provided they fall within the scope of their equivalents at the time of filing this application.

Exemplary embodiments of the present invention will be described in detail with reference to the accompanying drawings. The same reference numerals will be used throughout to designate the same or like elements in the accompanying drawings. Moreover, detailed descriptions related to well-known functions or configurations will be ruled out in order not to unnecessarily obscure subject matters of the present invention. In the drawings, the shapes and dimensions of some elements may be exaggerated, omitted or schematically illustrated. Also, the size of each element does not entirely reflect an actual size.

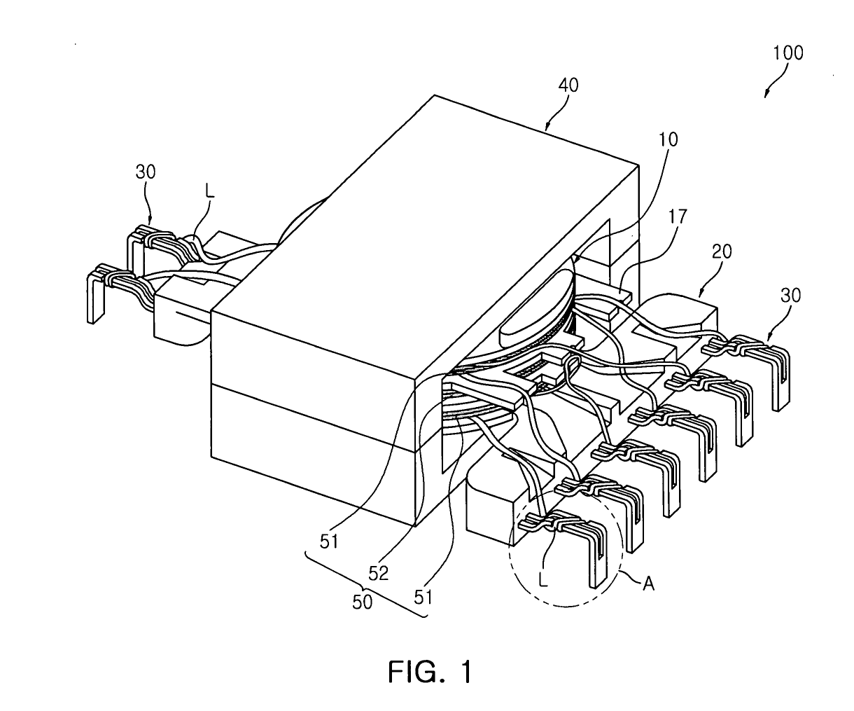

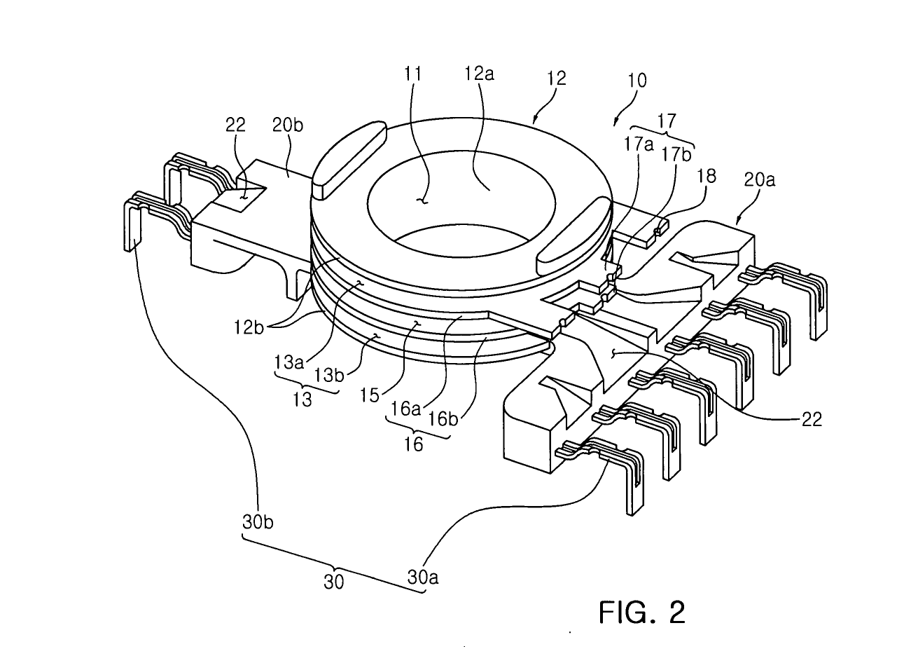

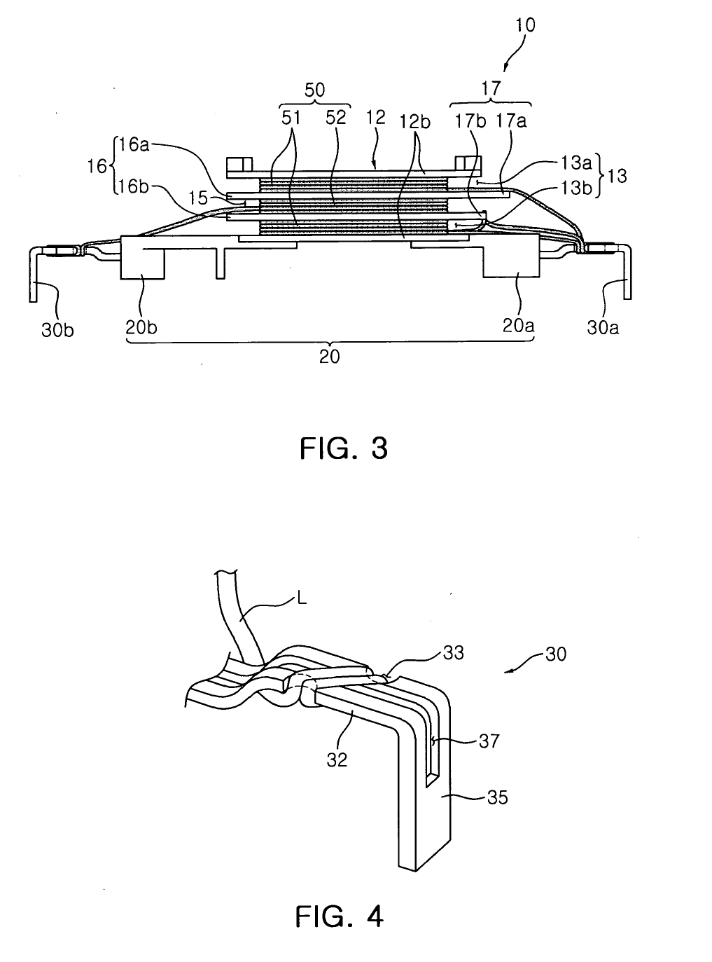

FIG. 1 is a schematic perspective view of a transformer according to an embodiment of the present invention, and FIG. 2 is a schematic perspective view of a bobbin of the transformer shown in FIG. 1. Further, FIG. 3 is a schematic side view of the bobbin, having a coil wound therearound, of FIG. 2.

Referring to FIGS. 1 through 3, a transformer 100 according to an embodiment of the present invention is an insulation-type switching transformer. The transformer 100 includes a coil 50, a bobbin 10, an external connection terminal 30, and a core 40.

The coil 50 includes a primary coil 51 and a secondary coil 52.

The primary coil 51 is wound on a primary winding portion 13 formed in a winding unit 12 to be described below. In the present embodiment, the winding unit 12 to be described below includes two primary winding portions 13a and 13b. Therefore, the primary coil 51 is wound on the two primary winding portions 13a and 13b to correspond to each other.

Further, in the case of the primary coil 51 according to the embodiment of the present invention, a plurality of coils which are electrically insulated from each other may be wound, in one primary winding portion 13. In regards to the primary coil 51 according to the exemplary embodiment, a case in which three different coils are wound in one primary winding portion 13 will be described as an example. Therefore, a total of six coils are wound on the two primary winding portions 13a and 13b, and as a result, a total of 12 lead wires L are drawn out to be connected to the external connection terminals 30 to be described below.

Meanwhile, in FIG. 1, for convenience of description, all the 12 lead wires L are not shown and only several lead wires are representatively shown.

As described above, in the transformer 100 according to the present embodiment, as the primary coil 51 includes the plurality of coils, various voltages may be applied. Further, various voltages may be drawn through the secondary coil 52 corresponding thereto.

Further, when a voltage is applied to any one of the plurality of primary coils 51, the voltage may even be drawn through the remainder of the primary coils 51 by electromagnetic induction. Therefore, this may be used in a display device to be described below.

For this, the plurality of coils forming the primary coil 51 may have different thicknesses and may be different in the number of turns thereof. Further, the primary coil 51 is not limited to three independent coils as described in this embodiment, and may include various numbers of coils as deemed necessary. This will be described in more detail in descriptions of other embodiments to be described below.

The second coil 52 is wound on a secondary winding portion 15 formed in the winding unit 12 to be described below.

Similarly to the primary coil 51, the secondary coil 52 may include a plurality of coils which are electrically insulated from each other.

The lead wires L of the primary coil 51 and the secondary coil 52 are connected to the external connection terminals 30 to be described below. This will be examined in more detail in a description of the external connection terminal 30 to be described below.

The bobbin 10 includes the winding unit 12 on which the coils 50 are wound and a base 20 formed on a lower end of the winding unit 12.

The winding unit 12 may include a body part 12a having a tubular shape and a flange part 12b extending from both ends of the body part 12a in an outer diameter direction.

A through-hole 11, into which a part of the core 40 is inserted, is formed in the body part 12a, and at least one partition 16 partitioning a space in a longitudinal direction of the body part 12a may be formed on an outer circumferential surface of the body part 12a. In this case, the coils 50 may be wound in spaces partitioned by the partition 16.

The winding unit 12 according to the present embodiment may include two partitions 16a and 16b. In more detail, the partition 16 according to this embodiment may include a first partition 16a disposed adjacent to an upper end of the bobbin 10 and a second partition 16b separated from the first partition 16a by a predetermined interval and disposed adjacent to the base 20 to be described below.

As a result, three partitioned spaces 13a, 13b, and 15 are formed in the winding unit 12 according to this embodiment. However, the present invention is not limited thereto, and various numbers of spaces may be formed by using various numbers of partitions 16 as deemed necessary.

Further, in the winding unit 12 according to the present embodiment, the primary coil 51 is wound in two end spaces among three partitioned spaces, i.e., both a space 13a between the upper end of the body part 12a and the first partition 16a and a space 13b between the lower end of the body part 12a and the second partition 16b (hereinafter, referred to as a primary winding portion), and the secondary coil 52 is wound in a space 15 between the first partition 16a and the second partition 16b (hereinafter, referred to as a secondary winding portion). However, the present invention is not limited thereto, and may be variously configured depending on the number or layout of partitioned spaces in the winding unit 12.

Further, the partition 16 of the winding unit 12 according to the present embodiment may have various thicknesses in order to minimize the influence of a voltage generated between the primary coil 51 and the secondary coil 52.

The partition 16 is used to electrically insulate the primary coil 51 and the secondary coil 52 from each other. Therefore, a coil wound on a predetermined winding portion (e.g., the primary winding portion) is not wound on another adjacent winding portion (e.g., the secondary winding portion) by skipping the partition 16, and as a result, the partition 16 according to the present embodiment does not have an additional groove, gap, slit, or the like on the circumferential portion thereof, except for a guide groove 18 to be described below.

Further, the partition 16 of the winding unit 12 according to the present embodiment is provided with at least one lead wire supporting portion 17 which protrudes outwardly from an end thereof. When the lead wires L of the coils 50 are connected to the external connection terminals 30, as the lead wires L are disposed to intersect with each other, the lead wire supporting portion 17 is provided to prevent the lead wires L of the coils 50 from contacting each other.

That is, the lead wire supporting portion 17 supports the lead wires L so that the lead wires L are connected with the external connection terminals 30 while being spaced apart from each other. The lead wire supporting portion 17 will be described in more detail in a description of the external connection terminal 30 to be described below.

The base 20 protrudes from each of both ends of the flange part 12b formed on the lower end of the winding unit 12 in an outer diameter direction and a downward direction. Further, the external connection terminals 30 are connected to each of bases 20a and 20b formed on the both ends of the flange part 12b while protruding outwardly.

More specifically, the base 20 according to the present embodiment includes a primary base 20a having an input terminal 30a and a secondary base 20b having an output terminal 30b. Referring to the drawings, in the present embodiment, the primary base 20a and the secondary base 20b are separately formed to be connected to the wiring unit 12 as an example. However, the present invention is not limited thereto, and the primary base 20a and the secondary base 20b may be integrally formed to be connected to the winding unit 12.

Further, the base 20 according to the present embodiment may be formed to allow both a distance between the winding unit 12 and the output terminal 30b and a distance between the winding unit 12 and the input terminal 30a to be 8 mm or more in order to secure an insulation distance between the input terminal 30a and the output terminal 30b.

However, this indicates a case limited to a small-sized insulation type switching transformer wound with a coil having a diameter of approximately 0.5 mm and may be modified depending on the thickness of the coil, a voltage applied to the coil, and the like.

The base 20 has a guide portion 22 guiding a path of the lead wire L on a surface thereof, i.e., the top surface on which the lead wire L leads. The guide portion 22 includes a plurality of grooves to guide the lead wires L, so as to easily connect the lead wires L to the external connection terminals 30 without contacting other lead wires L adjacent to the lead wires L.

To enable this, the guide portion 22 may have a plurality of separate grooves to correspond to positions where the external connection terminals 30 are disposed. Further, the guide portion 22 may have a funnel shape so that the lead wires L are guided by one groove together with the plurality of external connection terminals 30 adjacent to each other.

Further, in the guide portion 22 according to the present embodiment, the bottom surface of each of the grooves may be formed to be inclined at a predetermined angle or curved in order to minimize the bending of the lead wire L connected with the external connection terminal 30.

The bobbin 10 according to the present embodiment may be easily manufactured by injection molding, but is not limited thereto and may be manufactured by diversified methods such as a pressing process, and the like. Further, the bobbin 10 according to this embodiment may be made of an insulation resin and may be made of a material having high heat-resistance and high voltage-resistance. A material forming the bobbin 10 may include polyphenylsulfide (PPS), liquid crystal polyester (LCP), polybutyleneterephthalate (PBT), polyethyleneterephthalate (PET), a phenolic resin or the like.

The external connection terminals 30 protrude outwardly from the base 20 and may be formed in various forms according to the type or structure of the transformer 100, or the structure of a substrate on which the transformer 100 is mounted.

The external connection terminal 30 according to the present embodiment includes the input terminal 30a and the output terminal 30b.

The input terminal 30a is connected to the primary base 20a and is connected with the lead wire L of the primary coil 51 to supply power to the primary coil 51. Further, the output terminal 30b is connected to the secondary base 20b and is connected to the lead wire L of the secondary coil 52 to supply output power, set according to a turn ratio between the secondary coil 52 and the primary coil 51, to the outside.

The input terminal 30a and the output terminal 30b may have the same shape, and as deemed necessary, may have different shapes. Further, the external connection terminal 30 according to the present embodiment may be variously modified so long as the lead wire L can be connected therewith more easily.

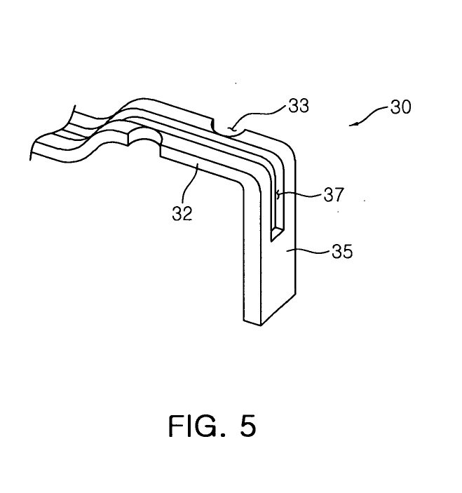

FIGS. 4 and 5 are enlarged views of part A of FIG. 1 and show the external connection terminal 30 according to the present embodiment in more detail. Herein, FIG. 5 shows the external connection terminal 30 without the lead wire L of the coil 50 shown in FIG. 4. Referring to FIGS. 4 and 5, the external connection terminal 30 according to the present embodiment includes a coil connector 32 protruding from the base 20 to be parallel to the base 20 and a substrate joint 35 extending downwardly from an end of the coil connector 32.

The coil connector 32 is a portion which the primary coil 51 or the secondary coil 52 is wound on to be connected thereto. The coil connector 32 has a coil guiding groove 33 formed on a side thereof.

The substrate joint 35 is inserted into a hole formed in the substrate (not shown) and electrically connected with the substrate through a solder or the like. The substrate joint 35 has a thickness (or a diameter) corresponding to the size of the hole formed in the substrate so that the substrate joint 35 can be easily inserted to the hole.

The external connection terminal 30 according to the present embodiment includes a rigidity reinforcing groove 37 and the coil guiding groove 33.

The rigidity reinforcing groove 37 is elongated in the length direction of the external connection terminal 30 and is formed in a surface of the external connection terminal 30. The rigidity reinforcing groove 37 is formed to reinforce the rigidity of the external connection terminal 30 and to prevent the external connection terminal 30 from being deformed or broken by applied external force while the coil 50 is connected to the external connection terminal 30.

The rigidity reinforcing groove 37 is formed by pressing only a part in which the rigidity reinforcing groove 37 is to be formed with respect to the external connection terminal having a predetermined thickness.

As a result, since a part of the external connection terminal 30, in which the rigidity reinforcing groove 37 is formed, has a density higher than other parts thereof, the corresponding part serves as a frame of the external connection terminal 30 and thus, is not easily deformed or broken and can maintain the rigidity even if an external force is applied thereto.

Meanwhile, in the present embodiment, the rigidity reinforcing groove 37 is formed throughout the coil connector 32 and the substrate joint 35; however, the present invention is not limited thereto. The rigidity reinforcing groove 37 may be formed in various forms depending on the shape and structure of the external connection terminal 30.

Further, although not shown, the other surface of the external connection terminal 30, in which the rigidity reinforcing groove 37 is not formed, is flattened. As described above, only the part of the external connection terminal 30, in which the rigidity reinforcing groove 37 is to be formed, is pressed to thereby increase the density thereof. However, the present invention is not limited thereto. That is, a protrusion having a predetermined height may be formed on the other surface of the external connection terminal 30 to correspond to the rigidity reinforcing groove 37. In this case, the rigidity of the external connection terminal 30 can be reinforced by a step (or a curve) formed by the rigidity reinforcing groove and the protrusion.

At least one coil guiding groove 33 may be formed in the side of the external connection terminal 30. In this embodiment, a total of two coil guiding grooves 33 are formed on both sides of the coil connector 32, respectively.

Meanwhile, as electronic apparatuses are miniaturized, an external connection terminal of a transformer has a reduced width. In the case in which the transformer 100 has a small size as described in this embodiment, the width of the external connection terminal 30 is further reduced.

As described above, in the case in which the coil guiding groove 33 is formed in the external connection terminal 30 having the very small width, the width of the part of the external connection terminal 30, in which the coil guiding groove 33 is formed, is further reduced, thereby weakening the rigidity of the external Connection terminal 30.

Accordingly, in the transformer 100 according to the present embodiment, the two coil guiding grooves 33 are disposed at different locations in order to prevent the rigidity of the external connection terminal 30 from being weakened due to the coil guiding groove 33. That is, the two coil guiding grooves 33 are formed to be spaced apart from each other by a predetermined interval in the length direction of the external connection terminal 30, in order to prevent a further reduction in the width of the external connection terminal 30 in the case in which the two coil guiding grooves 33 are positioned adjacent to each other. Herein, the coil guiding grooves 33 may be spaced apart from each other by a distance at least that of the width of the external connection terminal 30 or more.

Further, the coil guiding groove 33 may have a depth corresponding to a vertical distance from the side of the external connection terminal 30 to the rigidity reinforcing groove 37 in order to maintain the rigidity of the external connection terminal 30. However, the depth of the coil guiding groove 33 is not limited thereto.

As shown in FIG. 4, the lead wire L is inserted into the coil guiding grooves 33. As a result, the lead wire L connected to the external connection terminal 30 is prevented from being moved in the external connection terminal 30 by the coil guiding groove 33 to thereby improve the fixation force of the lead wire L. Therefore, the lead wire L can be more firmly and stably connected to the external connection terminal 30.

Further, in the transformer 100 according to the present embodiment, since the fixation force of the lead wire L is improved by the coil guiding grooves 33, it is not necessary for the lead wire L to be wound on the external connection terminal 30 several times in the related art. Accordingly, the connection process of the lead wire L is simplified and the quantity of the coil 50 used therein is reduced, whereby manufacturing costs can be reduced.

Moreover, since the coil 50 does not need to be excessively wound on the external connection terminal 30, even in the case that the external connection terminal 30 and the coil 50 are joined to each other by soldering, the amount of solder used therein can be reduced as compared with the related art.

As described above, the transformer 100 according to the present embodiment includes a plurality of (e.g., six) input terminals 30a. This is intended to allow a plurality of coils to be wound on one primary winding portion 13 in the transformer 100. However, the number of the input terminals 30a of the transformer 100 is not limited to six.

Further, in the transformer 100 according to the present embodiment, a plurality of (e.g., twelve) lead wires L of the primary coil 51 are connected to the input terminals 30a in a narrow space. Therefore, short circuits may occur due to intercontacts of the lead wires L.

In order to solve this problem, the transformer 100 according to the present embodiment includes the lead wire supporting portion 17 which protrudes outwardly from the end of the partition 16 in a horizontal manner. As described above, the lead wire supporting portion 17 is provided to prevent the lead wires L of the coils 50 from contacting each other. For this, the lead wire supporting portion 17 has at least one guide groove 18, guiding the route of the lead wires L, formed in the end thereof.

The lead wire supporting portion 17 may be provided on at least one of the first partition 16a and the second partition 16b. A plurality of lead wire supporting portions may protrude from one partition 16.

Further, when the plurality of lead wire supporting portions 17 are provided, the lead wire supporting portions 17 may have different protruding distances or the same protruding distance, and may protrude individually in various distances as deemed necessary.

Further, in the present embodiment, the lead wire supporting portion 17 protrudes to be parallel with respect to a disposed direction of the external connection terminal 30. In this case, since a mold can be easily separated from the bobbin 10 in injection molding, the manufacturing of the bobbin 10 may be relatively facilitated. However, the present invention is not limited thereto, and as deemed necessary, the lead wire supporting portion 17 may protrude in various directions.

Meanwhile, in the case of the transformer 100 according to the present embodiment, the directions, in which the lead wires L are led out from the primary coil 51 wound on the primary winding portion 13 and the secondary coil 52 wound on the secondary winding portion 15, differ from one another. Accordingly, the lead wires L of the primary coil 51 and the lead wires L of the secondary coil 52 are difficult to be short-circuited by each other.

However, since twelve lead wires L which are lead out from the primary winding portion 13a disposed above of the secondary winding portion 15 and the primary winding portion 13b disposed under the secondary winding portion 15 are all connected to the input terminals 30a, the twelve lead wires L may contact each other.

Accordingly, in order to address this problem, in the transformer 100 according to the present embodiment, the lead wires L, led out from the primary winding portion 13a disposed above the secondary winding portion 15, are spaced apart from each other through the lead wire supporting portion 17a formed on the first partition 16a, and the lead wires L, led out from the primary winding portion 13b disposed under the secondary winding portion 15, are supported to be spaced apart from each other through the lead wire supporting portion 17b formed on the second partition 16b and the guide portion 22 formed on the base 20.

Accordingly, the lead wires L, led out from the primary winding portion 13b disposed under the second winding portion 15, may be connected to the input terminals 30a through two routes, that is, they may be connected to the input terminals 30a along the guide portion 22 of the base 20 or may be connected to the input terminals 30a after being connected to the lead wire supporting portion 17b formed on the second partition 16b.

To this end, the lead wire supporting portions may have different protruding distances. In the present embodiment, the protruding distance of the lead wire supporting portion 17a formed on the first partition 16a is different from the protruded distance of the lead wire supporting portion 17b formed on the second partition 16b. In particular, the upper lead wire supporting portion 17a of the first partition 16a protrudes further than the lower lead wire supporting portion 17b of the second partition 16b, and more specifically, the lead wire supporting portion 17a of the first partition 16a protrudes further outwardly than the lead wire supporting portion 17b of the second partition 16b by 1 mm or more.

As described above, in the case in which the lead wire supporting portion 17a of the first partition 16a protrudes further than the lead wire supporting portion 17b of the second partition 16b, the lead wires L (the lead wires L led out from the upper primary winding portion 13a) passing through the lead wire supporting portion 17a of the first partition 16a may be connected to the input terminals 30a without interfering with the other lead wires L (the lead wires L led out from the lower primary winding portion 13b).

Further, the lead wire supporting portions 17 according to the present embodiment are spaced apart from each other so that the lead wires L can be easily spaced apart from each other. More specifically, the plurality of lead wire supporting portions 17 formed on one partition 16 may be disposed to be spaced apart from adjacent lead wire supporting portions 17 by at least 1 mm or more.

Meanwhile, the lead wire supporting portion 17 is not limited to the above configuration, and various numbers of lead wire supporting portions 17 may protrude in various forms as deemed necessary.

The guide groove 18 formed in the lead wire supporting portion 17 may have a size and a shape corresponding to the thickness of the coil 50. In the present embodiment, one guide groove 18 is formed in one lead wire supporting portion 17; however, the present invention is not limited thereto. That is, a plurality of guide grooves 18 may be formed in one lead wire supporting portion 17 as deemed necessary.

Further, in the present embodiment, one guide groove 18 is formed at the center of the end of the lead wire supporting portion 17; however, the present invention is not limited thereto. That is, the guide groove 18 may be formed in a direction in which the lead wire L connected to the external connection terminal 30 is led out from the winding unit 12 or in various directions to correspond to the location of the external connection terminal 30 to which the corresponding lead wire L is connected.

Furthermore, a part of the guide groove 18 which contacts the lead wire L may be curved so as to minimize a friction with the lead wire L.

A part of the core 40 is inserted into a through-hole 11 formed in the bobbin 10 to form a magnetic path electromagnetically coupling with the coil 50.

The core 40 according to the present embodiment is configured of a pair of cores being inserted into the through-hole of the bobbin 10 and connected to each other while facing each other. As the core 40, an ‘EE’ core, an ‘EI’ core, a ‘UU’ core, a ‘UI’ core or the like may be used.

Further, the core 40 may be made of Mn—Zn based ferrite having higher magnetic permeability, lower loss, higher saturated magnetic flux density, higher stability, and lower manufacturing costs than other materials. However, the shape and material of the core 40 are not limited thereto.

Meanwhile, although not shown, an insulation tape may be interposed between the bobbin 10 and the core 40 according to the present embodiment. The insulation tape may be provided to ensure insulation between the coil 50 wound on the bobbin 10 and the core 40.

The insulation tape may be interposed between the core 40 and the bobbin 10 corresponding to all internal surfaces of the core 40 facing the bobbin 10, or the insulation tape may be partially interposed therebetween in only a part in which the coil 50 and the core 40 face each other.

Meanwhile, the transformer is not limited to the above-mentioned embodiments and can be variously applied.

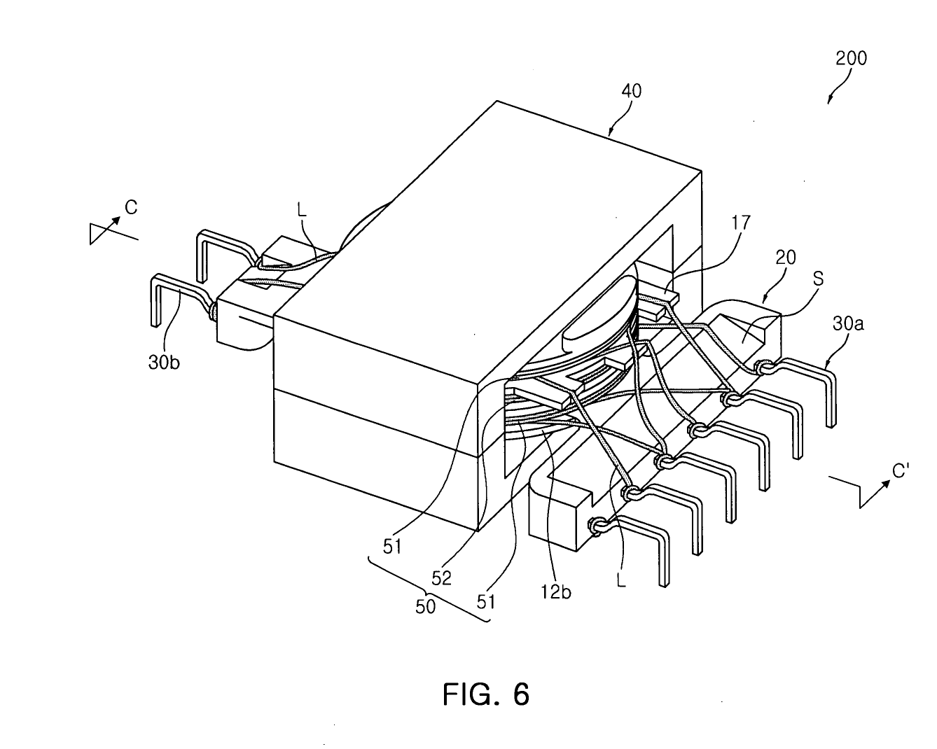

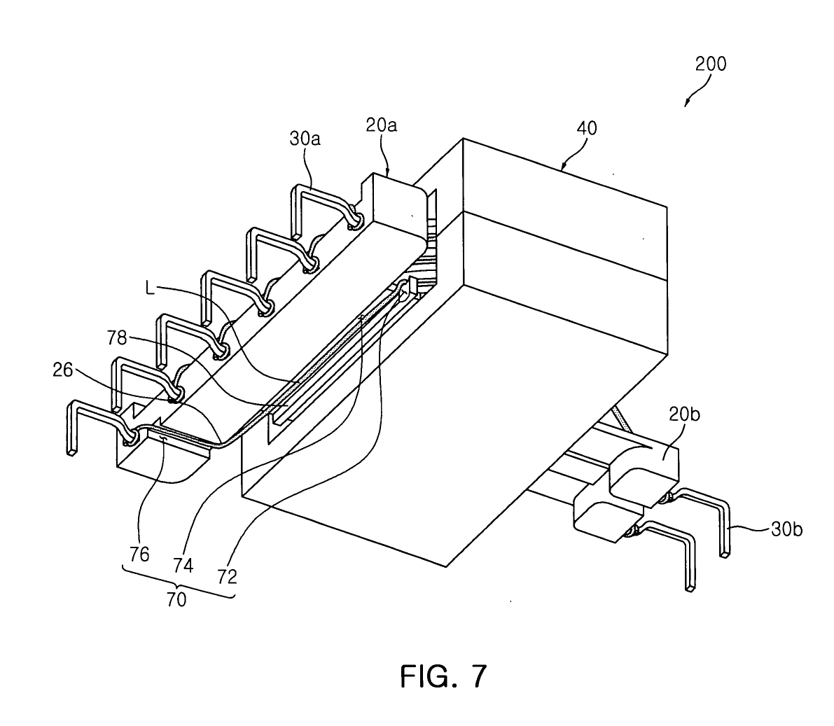

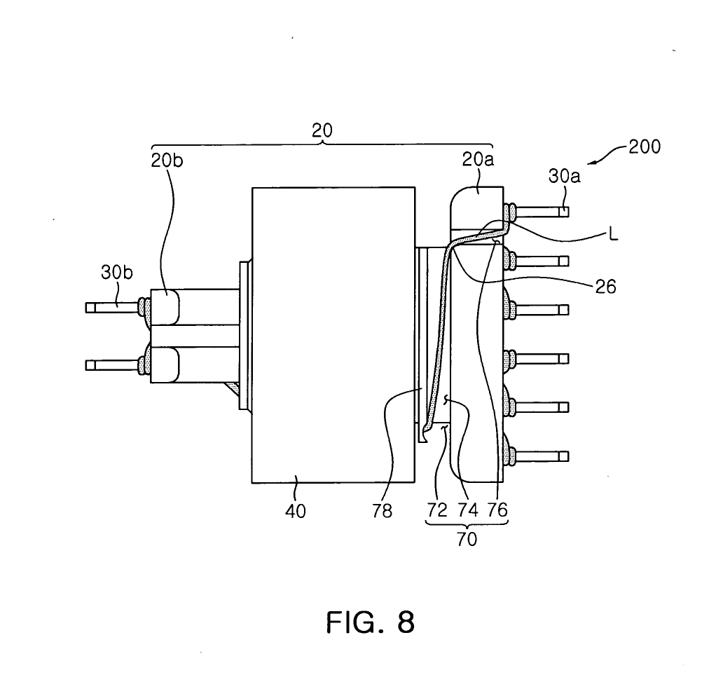

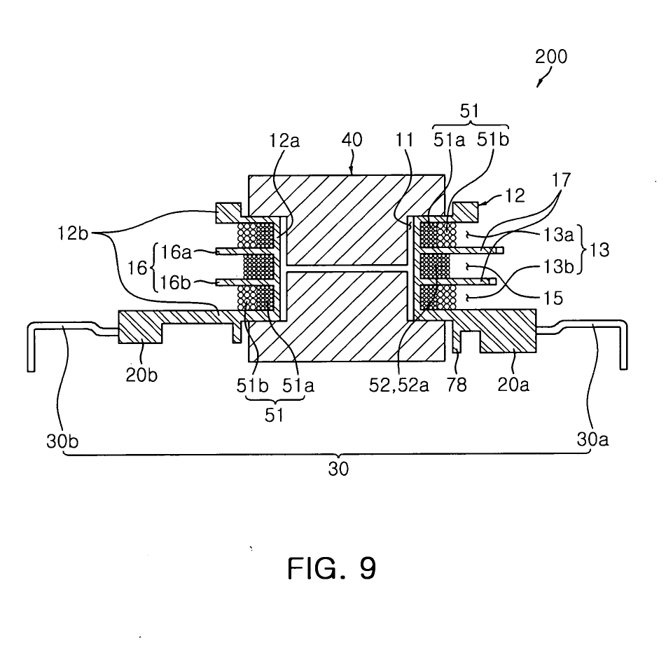

FIG. 6 is a perspective view of a transformer according to another embodiment of the present invention, FIG. 7 is a perspective view showing the bottom of the transformer shown in FIG. 6, and FIG. 8 is a bottom view of the transformer shown in FIG. 6. Further, FIG. 9 is across-sectional view taken along line C-C′ of FIG. 6.

Referring to FIGS. 6 through 9, the transformer 200 according to the embodiment of the present invention has a configuration similar to that of the transformer 100 (FIG. 1) of the above-mentioned embodiment, and is partially different therefrom. Therefore, a detailed description of the same configuration as that of the transformer according to the above-mentioned embodiment will be omitted and a different configuration will be mainly described.

The bobbin 10 includes the winding unit 12 on which the coil 50 is wound and the base 20 formed on the lower end of the winding unit 12, like the transformer 100 of FIG. 1. Further, the winding unit 12 may include the body part 12a having a tubular shape, the flange part 12b extending from both ends of the body part 12a in the outer diameter direction, and two partitions 16 formed on the body part 12a.

Among the spaces partitioned by the partitions 16 and the flange part 12b, the primary coil 51 is wound on the spaces 13 (i.e., the primary winding portion) formed at both ends thereof and the secondary coil 52 is wound on the space 15 (i.e., the secondary winding portion) formed at the center thereof.

Further, the partition 16 according to the present embodiment may include at least one lead wire supporting portion 17 protruding outwardly from an end thereof.

Meanwhile, the base 20 according to the present embodiment has a slope S in which a surface connected to the external connection terminal 30 from the flange part 12b is chamfered, as shown in FIG. 6.

Due to the above structure of the base 20, the coils 50 wound on the bobbin 10 may be easily connected to the external connection terminals 30 along the slope S of the base 20. Therefore, in the transformer 200 according to this embodiment, as the lead wires L are bent at the edge of the base 20, physical force applied to the bent portion can be minimized.

The base 20 may include the primary base 20a having the input terminal 30a and the secondary base 20b having the output terminal 30b.

The external connection terminals 30 may be connected to the base 20 to protrude outwardly or downwardly from the ends of the base 20.

Further, the transformer 200 according to the present embodiment uses a coil skipping unit 70 to be described below, in addition to the upper surface of the base 20, i.e., the slope S, in order to guide the lead wire L of the coil 50 to the external connection terminal 30.

As shown in FIGS. 7 and 8, the transformer 200 according to the present embodiment includes the coil skipping unit 70 on the side of the primary base 20a. In the present embodiment, since the primary coil 51 includes the plurality of lead wires L, the transformer 200 includes the coil skipping unit 70 to correspond to the primary coil 51. Therefore, the base 20 to be described below may basically refer to the primary base 20a as long as there is no additional limitation. Similarly, the coil 50 may refer to the primary coil 51.

However, the coil skipping unit 70 according to the present embodiment is not limited to being configured to correspond to the primary coil 51. That is, in a case in which the secondary coil 52 has a plurality of lead wires, the coil skipping unit 70 may be easily applied to even the secondary coil 52. However, for convenience of description, a case in which the coil skipping unit 70 is applied to only the primary coil 51 will be described as an example.

The coil skipping unit 70 provides a path in which the lead wire L of the coil 50 wound on the bobbin 10 skips to the lower surface of the base 20, rather than the upper surface of the base 20, to be connected to the external connection terminal 30.

The coil skipping unit 70 according to the present embodiment is formed by a guide block 78 and the base 20, and includes a skipping groove 72, a crossing path 74, and a guiding groove 76.

The guide block 78 is formed on the lower surface of the bobbin 10, and more specifically, may be formed on the lower surface of the flange part 12b. The guide block 78 fixes the movement of the core 40 coupled with the bobbin 10 and provides a passage where the lead wire L of the coil 51 is disposed in the lower part of the bobbin 10.

To enable this, the guide block 78 according to the present embodiment protrudes from a space between the primary base 20a and the through-hole 11 and is disposed to cross the lower surface of the flange part 12b of the bobbin 10 in parallel to the base 20.

Further, at least one end of both ends of the guide block 78 according to the present embodiment protrudes outwardly from the flange part 12b of the bobbin 10. In this case, a space between one protruded end of the guide block 78 and one end of the base 20 is used as the skipping groove 72.

The skipping groove 72 is formed by one end of the guide block 78 protruding outwardly from the outer periphery of the flange part 12b in a direction perpendicular thereto, one end of the base 20, and the flange part 12b provided therebetween, as described above. The skipping groove 72 is used as a path in which the lead wire L of the coil 50 wound on the bobbin 10 skips to the lower part of the bobbin 10.

Meanwhile, the skipping groove 72 in the present embodiment is formed as one end of the guide block 78 and one end of the base 20 protrude to the outside of the flange part 12b. However, the present invention is not limited thereto, and various configurations can be implemented. For example, one end of the guide block 78 and one end of the base 20 do not protrude, but a part of the flange part 12b between the guide block 78 and the base 20 is removed to form a groove. The groove may be provided in various forms so long as the groove can be formed in the outer periphery of the flange part 12b.

Further, in the transformer 200 according to the present embodiment, one end of the guide block 78 protruding from the flange part 12b of the bobbin 10 may have a hook shape in order to prevent the lead wire L from being separated from the skipping groove 72 while the lead wire L skips to the lower part of the bobbin 10.

The crossing path 74 is formed between the guide block 78 and the base 20. The crossing path 74 provides a passage crossing one portion of the lower surface of the flange part 12b. The crossing path 74 is used as a path in which the lead wire L of the coil 50 skipped through the skipping groove 72 is disposed in the length direction of the base 20.

The guiding groove 76 is formed in the lower surface of the base 20 and is used as a passage in which the lead wire L of the coil 50 disposed on the crossing path 74 is connected with the external connection terminal 30. That is, the guiding groove 76 allows a disposed direction of the lead wire L of the coil 50 disposed on the crossing path 74 to be switched to a direction in which the external connection terminal 30 is disposed.

To enable this, the guiding groove 76 crosses the base 20 in a transverse direction, and has one end communicating with the crossing path 74 and the other end opened to the outside of the base 20.

Meanwhile, the lead wire L of which the disposed direction is switched by the guiding groove 76 contacts an edge portion of a side wall of the guiding groove 76, and as a result, the lead wire L may be excessively curved or bent at the contact portion. Therefore, the guiding groove 76 according to the present embodiment may have a chamfered part 26 at the edge portion of the side wall thereof directly contacting the lead wire L.

In FIGS. 7 and 8, the chamfered part 26 is formed as a curved surface. However, the present invention is not limited thereto, and the chamfered part 26 may be formed as an inclined surface. The chamfered part 26 may have various shapes.

The plurality of guiding grooves 76 may be formed in parallel to correspond to the number of the lead wires L disposed on the crossing path 74 or the number of the external connection terminals 30 connected with the corresponding lead wires L.

A process in which the lead wire L of the coil 50 is disposed in the coil skipping unit 70 and connected to the external connection terminal 30 will be described below.

The lead wire L of the coil 50 wound on the bobbin 10 is wound on and connected to the external connection terminal 30. In this case, the lead wire L of the coil 50 (e.g., the primary coil) may be connected to the external connection terminal 30 along the slope S (FIG. 6) of the base 20 or connected to the external connection terminal 30 after moving to the lower surface of the bobbin 10 through the coil skipping unit 70.

The lead wire L led to the slope S of the base 20 may be directly connected to the external connection terminal 30.

On the contrary, when the lead wire L is connected with the external connection terminal 30 through the coil skipping unit 70, the lead wire L moves to the lower surface of the bobbin 10 through the skipping groove 72. In this case, since the moving of the lead wire L is prevented by the hook shape of one end of the guide block 78, the lead wire L is not easily separated from the skipping groove 72.

Subsequently, the lead wire L is disposed on the crossing path 74 formed on the lower surface of the bobbin 10 and thereafter, the lead wire L leads to a changed path while supporting the side wall (i.e., the chamfered part) of the guiding groove 76, thereby being connected with the external connection terminal 30.

In the present embodiment, the lead wire L leads to a vertically changed path by the guiding groove 76. However, the present invention is not limited thereto. The path of the lead wire L may be set by forming the side wall of the guiding groove 76 contacting the lead wire L in various angles so long as the lead wire L can be fixedly connected to the external connection terminal 30 without inference with lead wires L of other coils.

Further, the guiding groove 76 according to the present embodiment has the side wall contacting the lead wire L to be substantially vertical with respect to the lower surface of the guiding groove 76. This is intended to prevent the lead wire L supported by the side wall from being separated from the guiding groove 76.

Therefore, the guiding groove 76 is not limited to the above configuration, and the guiding groove 76 may have various shapes so long as the lead wire L supported by the side wall may not be separated therefrom. For example, the side wall of the guiding groove 76 contacting the lead wire L may make an acute angle with the lower surface of the guiding groove 76. A step or a groove may be formed in the chamfered part 26. That is, various applications may be implemented.

As described above, the coil skipping unit 70 according to the present embodiment is derived by considering a case in which the coil 50 is automatically wound on the bobbin 10.

That is, due to the coil skipping unit 70 according to the present embodiment, the process of winding the coil 50 on the bobbin 10, the process of skipping the lead wire L of the coil 50 to the lower surface of the bobbin 10 through the skipping groove 72 and disposing the lead wire L on the crossing path 74, and the process of leading the lead wire L toward the external connection terminal 30 by switching the path of the lead wire L through the guiding groove 76 and connecting the lead wire L to the external connection terminal 30 may be automatically performed through a separate automatic winding device (not shown).

As described above, the transformer 200 according to the present embodiment provides the coil skipping unit 70 which is the path in which the lead wire L of the coil 50 crosses the bobbin 10 on the lower surface of the bobbin 10.

As a result, since the lead wires L are distributively disposed on one surface (i.e., the slope of the base) and the other surface (i.e., the coil skipping unit) of the flange part 12b to be connected to the external connection terminals 30, the lead wires L of the coil 50 may be connected to the external connection terminals 30 through various paths as compared with the related art transformer.

In the related art, when the plurality of coils are wound on the bobbin, the lead wires of the coils led to the external connection terminal are disposed to intersect with each other, and as a result, the lead wires may contact each other, thereby causing a short-circuit between the coils.

However, since the transformer 200 according to the present embodiment provides a new path by the coil skipping unit 70 as described above, the lead wires L may be connected to the external connection terminal 30 through various paths. Accordingly, intersection or contact between the lead wires L may be prevented.

Further, like the above-mentioned embodiment, the coil 50 of the transformer 200 according to this embodiment may include the primary coil 51 and the secondary coil 52.

As shown in FIG. 9, the primary coil 51 is wound on the primary winding portion 13a. In the present embodiment, the winding unit 12 includes two primary winding portions 13a. Therefore, the primary coil 51 is wound on the two primary winding portions 13a to correspond to each other.

Further, in the case of the primary coil 51 according to the present embodiment, a plurality of coils 51a and 51b electrically insulated from each other may be wound on one primary winding portion 13a. In this embodiment, the two different coils 51a and 51b are used as the primary coil 51. Therefore, a total of four coils 51a and 51b are individually wound on the two primary winding portions 13a and 13b, and accordingly, a total of eight lead wires L lead to thereby be connected to the external connection terminals 30.

Meanwhile, for convenience of description, the primary coil 51 according to the present embodiment includes the two individual coils 51a and 51b; however, the present invention is not limited thereto. The primary coil 51 may include three individual coils or various numbers of coils as deemed necessary.

Further, in the transformer 200 according to the present embodiment, at least one of the coils 50 wound at the outermost portion of the winding unit 12 may be a triple insulated winding wire (TIW) in order to ensure insulation among the coils 50 wound on the winding unit 12.

Referring to FIG. 9, in the transformer 200 according to the exemplary embodiment, a general insulated coil 51a is wound on the inner portion of the winding unit 12, i.e., a part adjacent to the outer circumferential surface of the body part 12a, and a triple insulated winding wire 51b is wound on the outer portion of the winding unit 12, i.e., a part adjacent to the outer periphery of the partition 16.

More specifically, the primary coil 51 according to the present embodiment includes at least one general insulated coil 51a and at least one triple insulated coil 51b. In addition, the triple insulated coil 51b is wound to be disposed at the outermost portion of the primary winding portion 13.

Herein, the triple insulated coil 51b is a coil having improved insulation properties by forming a three-layer insulator on an outer portion of a conductor. When the triple insulated coil 51b is used, insulation properties between the conductor and the outside may be easily ensured, whereby an insulation distance between the coils may be minimized. However, this triple insulated coil has increased manufacturing costs as compared to the general insulated coil 51a.

Therefore, in the transformer 200 according to this embodiment, the general insulated coils 51a and 52a are basically used as the primary coil 51 and the secondary coil 52, and the triple insulated coil 51b is only used as the coil disposed at the outermost portion of the winding unit 12.

As shown in FIG. 9, the triple insulated coil 51b is only used as the primary coil 51 wound on the primary winding portion 13. In this case, since an insulation distance and a creepage distance between the general insulated coil 51a of the primary winding portion 13 and the general insulated coil 52a of the secondary winding portion 15 are significantly secured by the partition 16, insulation therebetween may be achieved.

In addition, a distance (particularly, creepage distance) between the triple insulated coil 51b of the primary winding portion 13 and the general insulated coil 52a of the secondary winding portion 15 is very small; however, since the primary coil 51 includes the triple insulated coil 51b having high insulation properties, insulation from the secondary coil 52 may be achieved.

Therefore, when the coil 50 is wound as shown in FIG. 9, insulation between the primary coil 51 and the secondary coil 52 can be easily achieved while the use of the triple insulated winding wire 51b is minimized.

However, the present invention is not limited thereto and various applications can be implemented. For example, the general insulated coil is wound on the primary winding portion 13 and the triple insulated coil is used as the secondary coil 52 wound on the secondary winding portion 15. Further, by considering the number of turns of individual coils 50 and the creepage distance between the coils 50, the position and quantity of the triple insulated coil used therein may be appropriately controlled.

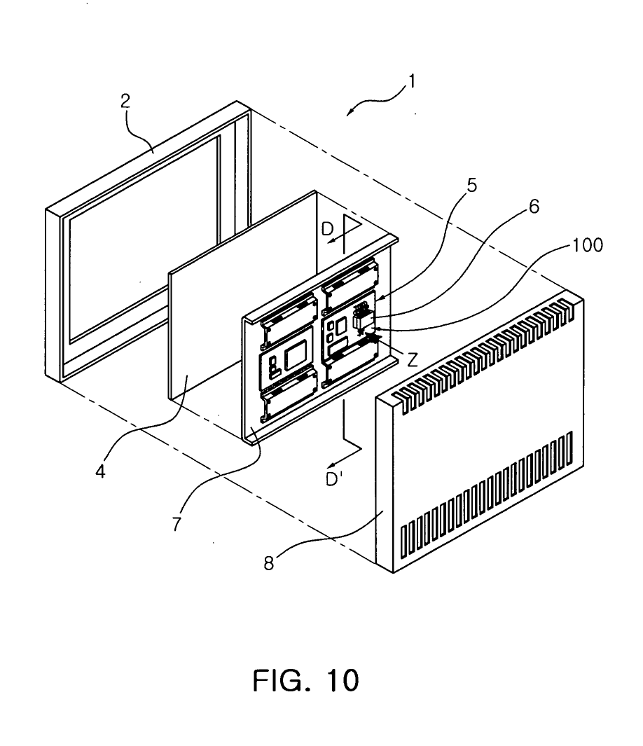

FIG. 10 is a schematic exploded perspective, view of a flat panel display device according to an embodiment of the present invention.

Referring to FIG. 10, a flat panel display device 1 according to the embodiment of the present invention may include a display panel 4, a switching mode power supply (SMPS) 5 having the transformer 100 mounted therein, and a cover 2 and 8.

The cover includes a front cover 2 and a back cover 8, which are coupled with each other to form an internal space therebetween.

The display panel 4 is disposed in the internal space formed by the covers 2 and 8, and various flat panel display panels such as a liquid crystal display (LCD), a plasma display panel (PDP), and an organic light emitting diode (OLED) may be used therefor.

The SMPS 5 provides power to the display panel 4. The SMPS 5 may be formed by mounting a plurality of electronic components on a printed circuit board 6, and in particular, may include at least one of the transformers 100 and 200 according to the above-mentioned embodiments mounted therein. In the present embodiment, the SMPS includes the transformer 100 of FIG. 1 by way of example.

The SMPS 5 may be fixed to a chassis 7 and may be fixedly disposed in the internal space formed by the covers 2 and 8.

Here, the transformer 100 mounted in the SMPS 5 has the coil 50 (See FIG. 1) wound in a direction that is parallel with the printed circuit board 6. Further, when viewed from a plane of the printed circuit board 6 (a Z direction), the coil 50 is wound clockwise or counterclockwise. In addition, a part (that is, the upper surface) of the core 40 forms a magnetic path while being parallel with the back cover 8.

Therefore, in the transformer 100 according to the present embodiment, a magnetic path of most magnetic flux formed between the back cover 8 and the transformer 100 among a magnetic field generated by the coil 50 is formed in the core 40, whereby the generation of leakage magnetic flux between the back cover 8 and the transformer 100 may be minimized.

As described above, even if the transformer 100 according to the present embodiment does not include a separate shielding device on the outside thereof, the generation of leakage magnetic flux may be minimized between the transformer 100 and the back cover 8 made of a metal material. Therefore, vibrations of the back cover 8 may be prevented due to interference between the leakage magnetic flux of the transformer 100 and the metallic back cover 8.

Therefore, even if the transformer 100 is mounted in a thin electronic device such as the flat panel display device and the back cover 8 and the transformer 100 have a significantly narrow space therebetween, the generation of noise due to vibrations of the back cover 8 may be prevented.

As set forth above, in a transformer according to exemplary embodiments of the invention, lead wires of coils are disposed to be separated from each other at regular intervals by a lead wire supporting portion protruding outwardly from a partition in a horizontal manner. Accordingly, even in the case that a plurality of coil lead wires are connected to external connection terminals in a narrow space, interference or short-circuits between the lead wires can be prevented.

Further, in the transformer according to the embodiments of the invention, since a rigidity reinforcing groove is formed in the external connection terminal, the external connection terminal can be prevented from being bent or broken even in the case that external force is applied to the external connection terminal when the lead wires of the coils are connected to the external connection terminal.

Moreover, in the transformer according to the embodiments of the invention, the fixation force of the lead wire connected to the external connection terminal is improved by a coil guiding groove formed in the external connection terminal. Accordingly, since the lead wires do not need to be excessively wound on the external connection terminal as described in the related art, a connection process of the lead wires is simplified and the quantity of coils used therein is reduced, whereby manufacturing costs can be reduced.

Further, in the transformer according to the embodiments of the invention, a coil wound at the outermost portion among coils wound on at least one winding portion is a triple insulated winding wire. Accordingly, since insulation between a primary coil wound on a primary winding portion and a secondary coil wound on a secondary winding portion is easily secured, the size of partitions dividing a winding unit may be minimized, such that the size of a bobbin may be reduced. Therefore, the transformer can be manufactured to be a small size.

Further, the transformer according to the embodiments of the invention is configured to be suitable for an automated manufacturing method. That is, in the transformer according to the embodiments of the invention, the primary coil and the secondary coil may be automatically wound on the bobbin. Here, the coils may be wound by using a separate automatic winding device. Therefore, the manufacturing time and costs thereof can be remarkably reduced.

Further, the transformer according to the embodiments of the invention includes a coil skipping unit which is a path in which the lead wires of the coils cross the bobbin on the lower surface of the bobbin. That is, the coils may be connected with the external connection terminals through the lower surface of a base as well as the upper surface thereof.

Therefore, since the lead wires of the coils may be connected with the external connection terminals through more paths, the generation of a short circuit due to contact between the lead wires may be prevented.

Further, when the transformer according to the embodiments of the invention is mounted on a substrate, the coil of the transformer is maintained in a state in which it is wound to be parallel with the substrate. When the coil is wound to be parallel with the substrate, interference between the leakage magnetic flux generated from the transformer and the outside may be minimized.

Therefore, even if the transformer is mounted in a thin display device, the generation of the interference between the leakage magnetic flux generated from the transformer and the back cover of the display device may be minimized. Therefore, a phenomenon in which noise is generated in the display device by the transformer may be prevented. Therefore, the transformer may be easily used in thin display devices.

Meanwhile, the transformer according to the exemplary embodiments of the present invention is not limited to the above-mentioned exemplary embodiments and can be variously modified. For example, in the above-mentioned exemplary embodiments, the case in which two coil guiding grooves are formed in the external connection terminal is described as an example. However, the present invention is not limited thereto, and a plurality of coil guiding grooves may be formed as deemed necessary. Furthermore, various modifications, such as a case in which grooves are successively formed in both sides of the external connection terminal, and the like, can be made thereto.

Further, the rigidity of the external connection terminal can also be reinforced by bending the external connection terminal at a predetermined angle on the basis of a baseline in the length direction thereof.

Further, in the case in which the rigidity of the external connection terminal is ensured, the external connection terminal may include only the coil guiding groove without the rigidity reinforcing groove.

In addition, in the above-described embodiment, an insulation type switching transformer is described as an example. However, the present invention is not limited thereto, and may widely adopt transformers or electronic apparatuses that include coils and an external connection terminal on which lead wires of the coils are wound.

While the present invention has been shown and described in connection with the embodiments, it will be apparent to those skilled in the art that modifications and variations can be made without departing from the spirit and scope of the invention as defined by the appended claims.

What is claimed is:

1. A transformer comprising:
a winding unit having a plurality of partitions formed on an outer circumferential surface of a tubular body part;
a base provided at one end of the winding unit and including at least one external connection terminal protruding outwardly;
a coil wound on a bobbin and having a lead wire connected to the external connection terminal; and
a core electromagnetically coupled with the coil to thereby form a magnetic path,
wherein the bobbin includes at least one lead wire supporting portion protruding outwardly from the partitions, supporting the lead wire and guiding the lead wire to the external connection terminal.

2. The transformer of claim 1, wherein the partitions include:
a first partition disposed adjacent to the other end of the winding unit; and
a second partition spaced apart from the first partition by a predetermined interval and disposed adjacent to the base,
wherein the lead wire supporting portion is provided on at least one of the first partition and the second partition.

3. The transformer of claim 2, wherein the lead wire supporting portion provided on the first partition protrudes further than the lead wire supporting portion provided on the second partition.

4. The transformer of claim 2, wherein the lead wire supporting portion protrudes in parallel to the external connection terminal.

5. The transformer of claim 2, wherein the coil includes:
a primary coil wound in a space between the other end of the winding unit and the first partition and in a space between one end of the winding unit and the second partition; and
a secondary coil wound in a space between the first partition and the second partition.

6. The transformer of claim 5, wherein lead wires of the primary coil wound between the other end of the winding unit and the first partition are connected to the external connection terminal while being supported by the lead wire supporting portion protruding from the first partition.

7. The transformer of claim 5, wherein the base includes a groove-type guide portion guiding the lead wire to the external connection terminal.

8. The transformer of claim 7, wherein lead wires of the primary coil wound on the space between one end of the winding unit and the second partition are connected to the external connection terminal while being supported by at least one of the lead wire supporting portion protruding from the second partition and the guide portion of the base.

9. The transformer of claim 5, wherein the primary coil or the secondary coil includes a plurality of coils electrically insulated from each other.

10. The transformer of claim 9, wherein the primary coil or the secondary coil includes at least one general insulated coil and at least one triple insulated coil, and
the triple insulated coil is wound to be disposed at an outermost portion of the winding unit.

11. The transformer of claim 1, wherein the plurality of lead wire supporting portions protruding from the partitions have different protruding distances.

12. The transformer of claim 1, wherein the lead wire supporting portion includes at least one guide groove into which the lead wire is inserted.

13. The transformer of claim 12, wherein the lead wire supporting portion has a curved surface in contact with the lead wire.

14. The transformer of claim 1, wherein the external connection terminal includes a rigidity reinforcing groove elongated in a length direction and reinforcing a rigidity of the external connection terminal.

15. The transformer of claim 14, wherein the rigidity reinforcing groove is formed by a pressing process.

16. The transformer of claim 14, wherein the external connection terminal has higher density in a portion thereof, in which the rigidity reinforcing groove is formed, as compared with the remaining portion thereof.

17. The transformer of claim 1, wherein the external connection terminal has at least one coil guiding groove in a side thereof, the at least one coil guiding groove having the lead wire inserted therein when the lead wire of the coil is connected thereto.

18. The transformer of claim 17, wherein the coil guiding groove is formed in each of both sides of the external connection terminal.

19. The transformer of claim 1, wherein the winding unit has flange parts protruding outwardly from both ends of the body part, and
the base is provided at an end of at least one flange part.

20. The transformer of claim 19, further comprising a coil skipping unit which is a path for skipping the lead wire to an outer surface of the flange part through an outer periphery of the flange part and connecting the lead wire to the external connection terminal.

21. The transformer of claim 20, wherein the coil skipping unit includes:
a skipping groove providing a path in which the lead wire moves to a lower surface of the flange part; and
a crossing path providing a path in which the lead wire skipped through the skipping groove is disposed to cross the outer surface of the flange part.

22. The transformer of claim 21, wherein the coil skipping unit is a path formed between the base and a guide block protruding in parallel to the base from the outer surface of the flange part.

23. The transformer of claim 22, wherein the guide block has an end protruding outwardly from the outer periphery of the flange part, and
the skipping groove is formed by the protruding end of the guide block, the base, and the flange part.

24. The transformer of claim 23, wherein the base includes a groove-shaped guide portion guiding the lead wire to the external connection terminal, and
the lead wire is connected to the external connection terminal via the guide portion or the coil skipping unit.

25. The transformer of claim 22, wherein the coil skipping unit further includes at least one guiding groove formed in a lower surface of the base and switching the lead wire disposed on the crossing path to a direction in which the external connection terminal is disposed.

26. The transformer of claim 25, wherein the guiding groove has a chamfered part at an edge portion of a side wall contacting the lead wire.

27. A transformer, comprising:
a winding unit including a tubular body part having a through-hole formed therein and flange parts protruding outwardly from both ends of the body part;
a base provided at an end of at least one flange part and having a plurality of external connection terminals disposed thereon; and
at least one coil wound on a space formed by an outer circumferential surface of the body part and one surface of the flange part,
wherein lead wires of the coil are distributively disposed on one surface and the other surface of the flange part and connected to the external connection terminals so that the lead wires are prevented from intersecting with each other.

28. A transformer, comprising:
a winding unit on which a coil is wound; and
at least one external connection terminal protruding outwardly from an end of the winding unit,
wherein the external connection terminal includes a rigidity reinforcing groove elongated in a length direction and reinforcing a rigidity of the external connection terminal.

29. A transformer, comprising:
a winding unit on which a coil is wound; and
at least one external connection terminal protruding outwardly from an end of the winding unit,
wherein the external connection terminal includes at least one coil guiding groove in a side thereof, the at least one coil guiding groove having a lead wire of the coil inserted therein when the lead wire of the coil is connected thereto.

30. A transformer, comprising:
a winding unit having a plurality of partitions formed on an outer circumferential surface of a tubular body part;
a base provided at an end of the winding unit and including at least one external connection terminal protruding outwardly;
a coil wound on a bobbin and having a lead wire connected to the external connection terminal; and
a core electromagnetically coupled with the coil to thereby form a magnetic path,
wherein the coil includes at least one general insulated coil and at least one triple insulated coil, and
the triple insulated coil is wound to be disposed at an outermost portion of the winding unit.

31. A flat panel display device, comprising:
a power supply including at least one transformer of claim 1 mounted on a substrate thereof;
a display panel receiving power from the power supply, and
a cover protecting the display panel and the power supply.

32. The flat panel display device of claim 31, wherein the coil of the transformer is wound so as to be parallel with the substrate of the power supply.
